(19) United States
(12) Patent Application Publication
(10) Pub. No.: US 2005/0259022 A1
(43) Pub. Date: Nov. 24, 2005

(54) Collapsible indoor television antenna assembly

(75) Inventor: Cheng-Si Wang, Changhua Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: Trans Electric Co., Ltd., Changhua Hsien (TW)

(21) Appl. No.: 10/850,475

(22) Filed: May 20, 2004

(51) Int. Cl. H01Q 3/00

(52) U.S. Cl. 343/764

(57) ABSTRACT

A collapsible indoor television antenna assembly includes a base, a VHF antenna set and a UHF antenna. The base has a top, a top recess and an annular rib with a pivot slot formed on the top of the base to define the top recess. The UHF antenna includes a pivot assembly and a disk antenna. The pivot assembly is mounted in the pivot slot. The disk antenna is collapsible, is rotatably mounted on the pivot assembly and is received in the top recess. The VHF antenna set includes two connection rods and two collapsible dipole antennas. The connection rods are retractably and rotatably mounted in the base. The dipole antennas are pivotally connected to the connection rods and are retracted into the base. Consequently, the foldable UHF and VHF antennas make the entire indoor television antenna assembly compact to save packaging materials and storage space.

### BACKGROUND OF THE INVENTION

1. Field of the Invention

The present invention relates to an indoor television antenna assembly, and more particularly to an indoor television antenna assembly having both a collapsible VHF antenna set and a collapsible UHF antenna to render the television antenna assembly compact when the UHF and VHF antennas are not in use.

2. Description of Related Art

Indoor television antennas are connected to televisions for receiving television signals transmitted from television stations. The television signals operate generally at very high frequency (VHF) band and ultrahigh frequency (UHF) band. Therefore, a conventional television needs typically both VHF and UHF antennas to receive respectively the television signals provided at different bands.

The conventional indoor television antenna in accordance with the prior art comprises a base, a VHF antenna set and a UHF antenna. The UHF and VHF antennas are attached to the base and can be spread and adjusted to receive efficiently the television signals. However, the VHF and UHF antennas of the conventional indoor television antenna cannot be completely folded relative to the body and hidden entirely by the body when not in use. The conventional television antenna will need a bulky box to package the entire television antenna inside for storage, transport or selling. Using the bulky box to package the television antenna will waste packaging materials and needs large storage space in stock rooms.

Furthermore, the package box for the conventional television antenna cannot have a specific shape and eye-catching design because the unfolded VHF and UHF antennas extend outward relative to the base. The conventional television antenna packaged with a regular package box cannot attract consumers when the consumers want to purchase the indoor television antennas.

To overcome the shortcomings, the present invention provides a compact indoor television antenna assembly that has both collapsible VHF and UHF antennas for a size reduction when not in use to mitigate or obviate the aforementioned problems.

### SUMMARY OF THE INVENTION

The main objective of the invention is to provide a compact indoor television antenna assembly that has collapsible VHF and UHF antennas for a size reduction when the television antenna assembly is not in use to save packaging materials and storage space.

A collapsible indoor television antenna assembly includes a base, a VHF antenna set and a UHF antenna. The base has a top, a bottom, a top recess and an annular rib with a pivot slot formed on the top of the base to define the top recess. The annular rib includes a latch and a release button. The latch is retractably mounted in the annular rib and extends into the top recess. The release button is mounted on the annular rib and connects to and retracts the latch inward the annular rib as the release button is pressed. The UHF antenna includes a pivot assembly and a disk antenna. The pivot assembly is mounted in the pivot slot. The disk antenna is rotatably mounted on the pivot assembly, is received in the top recess and has a lip to engage the latch to hold the disk antenna in the top recess. The VHF antenna set includes two connection rods and two dipole antennas. The connection rods are retractably and rotatably mounted in the base and each of the connection rods has an outer end. The dipole antennas are pivotally mounted at the outer ends of the connection rods, are retracted into the base and have respectively distal tips extended out of the base so that a person will easily pull the dipole antennas out of the base by grasping the distal tips.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an indoor television antenna assembly in accordance with the present invention when the television antenna is not in use;

FIG. 2 is an operational perspective view of the indoor television antenna assembly in FIG. 1;

FIG. 3 is an exploded perspective view of a part of the indoor television antenna assembly in FIG. 1;

FIG. 4 is an operational side plan view of the indoor television antenna assembly in FIG. 1 when a VHF antenna set is being adjusted;

FIG. 5 is an operational side plan view of the indoor television antenna assembly in FIG. 1 when a UHF antenna is being adjusted; and

FIG. 6 is an operational perspective view of the television antenna assembly in FIG. 1 when the indoor television antenna is packaged in a specific box.

### DETAILED DESCRIPTION OF PREFERRED EMBODIMENT

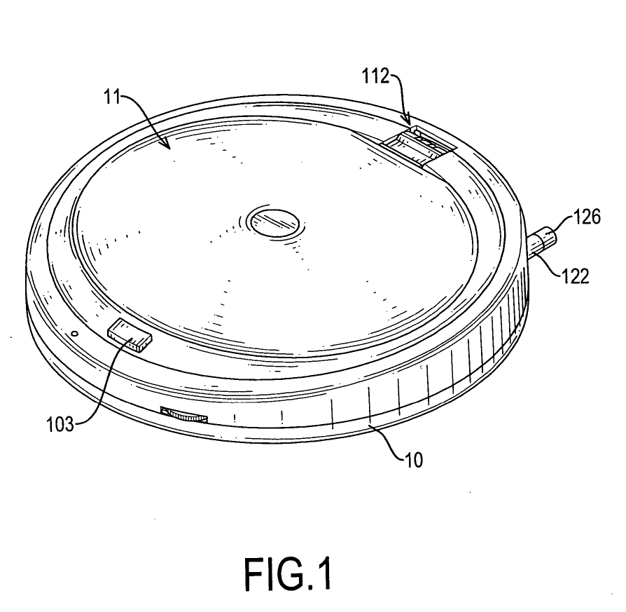

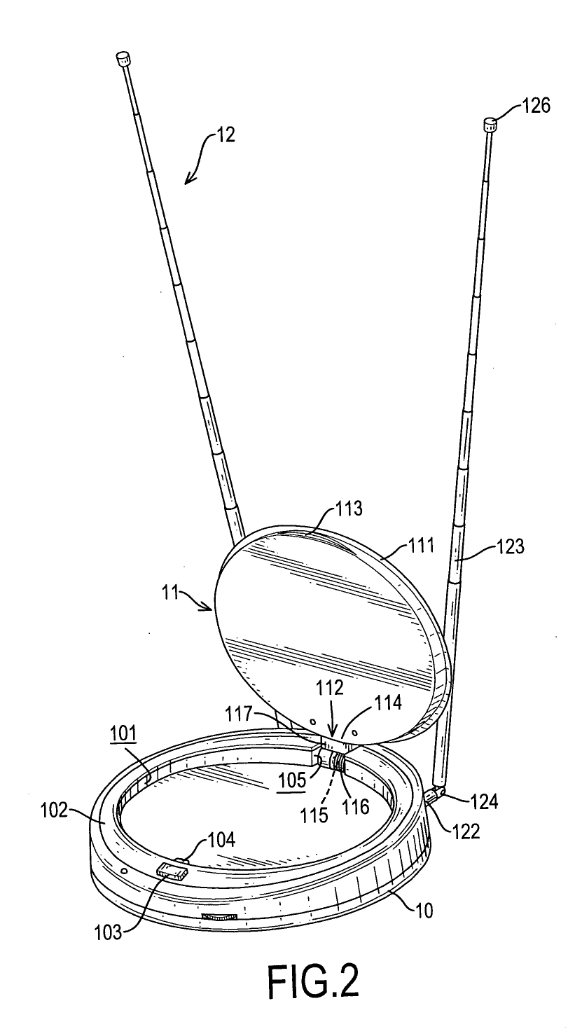

With reference to FIGS. 1, 2 and 3, an indoor television antenna assembly in accordance with the present invention comprises a base (10), a UHF antenna (11) and a VHF antenna set (12).

The base (10) is used to mount on a surface and comprises two casing portions. The base (10) may be shaped as a hollow thick disk and has a top, a bottom, a top recess (101) and an annular rib (102). The annular rib (102) is formed on the top of the base (10), defines the top recess (101) and has a pivot slot (105). The annular rib (102) comprises a release button (103) and a latch (104). The release button (103) connects to and retracts the latch (104) inward to the annular rib (102) as the release button (103) is pressed. The latch (104) is retractably mounted in the annular rib (102) and extends into the top recess (101) to engage the UHF antenna (11).

The base (10) further has two parallel inner tracks (106). The inner tracks (106) are formed along the interior of the base (10).

The UHF antenna (11) is pivotally mounted on the base (10) and comprises a disk antenna (111) and a pivot assembly (112). The disk antenna (111) is rotatably mounted on the pivot assembly (112) and has a lip (113) and a lower junction (114). The disk antenna (111) is operated at either a folded position or an unfolded position. When the disk antenna (111) is at the folded position, the disk antenna (111) is completely received and held in the top recess (101) with the lip (113) engaging the latch (104). The lower junction (114) is rotatably connected to the pivot assembly (112).

The pivot assembly (112) is mounted in the pivot slot (105) and comprises a pivot rod (115), a restitution element (116) and a pivot seat (117). The pivot rod (115) is transversally mounted in the pivot slot (105). The restitution element (116) may be a coil spring and is mounted around the pivot rod (115). The pivot seat (117) is pivotally mounted on the pivot rod (115) and connects to the restitution element (116) and rotatably connects to the lower junction (114) of the disk antenna (111). Therefore, the restitution element (116) will be compressed by the pivotal movement of the disk antenna (111) through the pivot seat (117) when the disk antenna (111) is kept in the top recess (101) at the folded position. The compressed restitution element (116) will lift the disk antenna (111) up from the folded position to the unfolded position through the pivot seat (117) when the release button (113) is pressed to disengage the lip (113) from the latch (104).

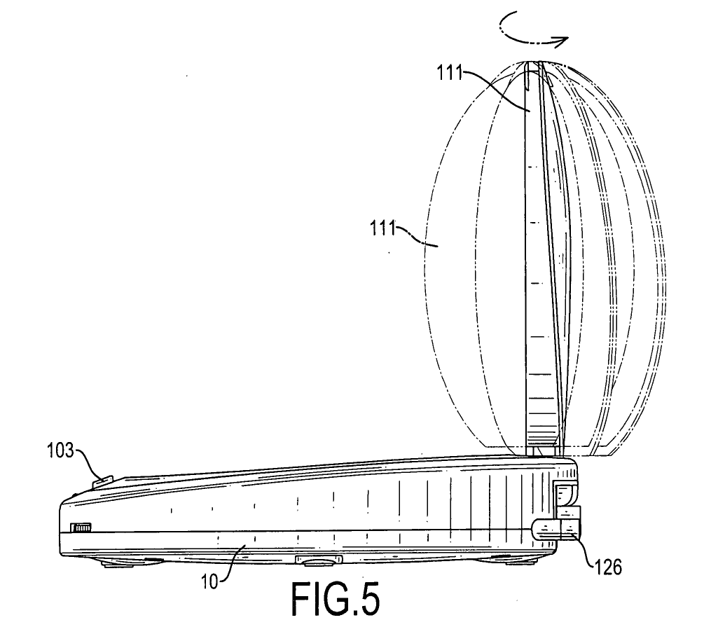

With reference to FIG. 5, the unfolded disk antenna (111) can be rotated relative to the pivot seat (117) to adjust the positions of the disk antenna (111) when the disk antenna (111) is held at the unfolded position, hence, using and adjusting the disk antenna (111) is really easy and convenient.

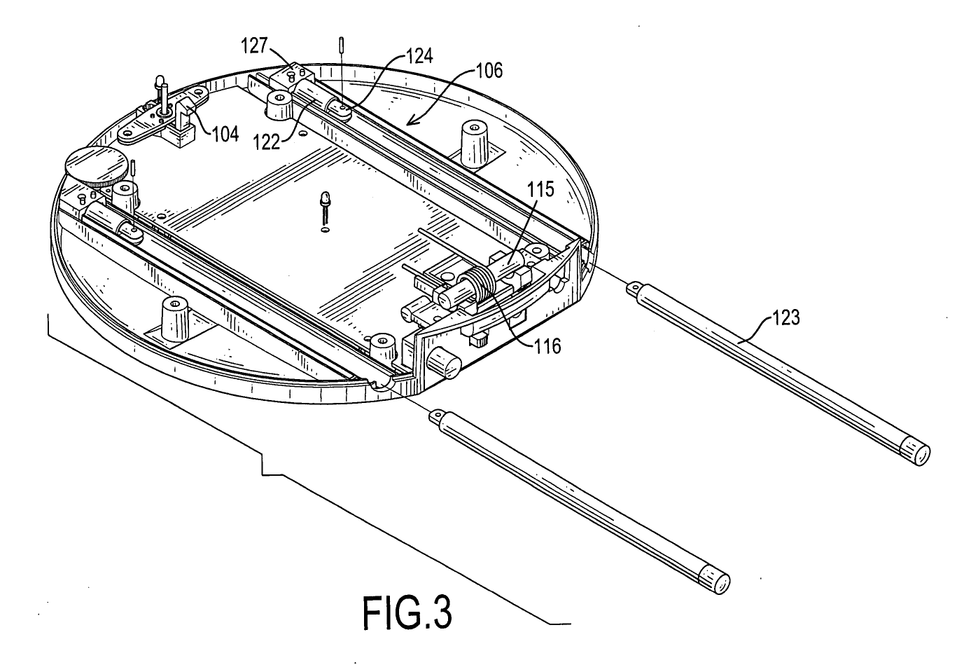

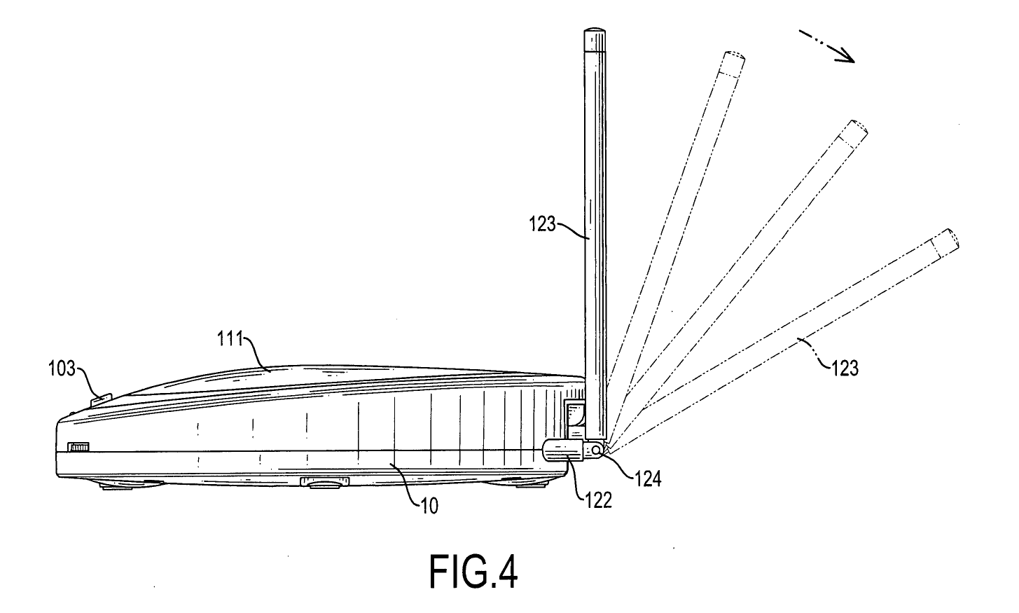

With reference to FIGS. 3 and 4, the VHF antenna set (12) is retractably mounted in the base (10) and will be retracted in the base (10) along the inner tracks (106) when not in use. The VHF antenna set (12) comprises two inner connection rods (122), two dipole antennas (123) and two inner sliding blocks (127).

The inner sliding blocks (127) are respectively and slidably mounted on the inner tracks (106). The inner connection rods (122) are respectively and rotatably attached to the inner sliding blocks (127), and each of the inner connection rods (122) has an outer end (124). The outer ends (124) of the inner connection rods (122) can extend out of the base (10). The dipole antennas (123) are pivotally and respectively mounted at the outer ends (124) of the inner connection rods (122) and may be telescopic antennas. Each of the dipole antennas (123) has distal tip (126). The distal tips (126) extend out of the base (10) so that a person will easily pull the dipole antennas (123) out of the base (10) by grasping the distal tips (126).

The dipole antennas (123) can be retracted into and held in the base (10) except for the distal tips (126) to hide the dipole antennas (123) in the base (10) when the dipole antennas (123) are not in use. A person can completely extend the dipole antennas (123) out of the base (10), spread and extend the dipole antennas (123) to adequate lengths and adjust angular positions of the dipole antennas (123) relative to the base (10) to receive television signals. The inner sliding blocks (127) will stop the movements of the inner connection rods (122) to prevent the inner connection rods (122) from being completely drawn out of the base (10) while pulling the dipole antennas (123) out of the base (10).

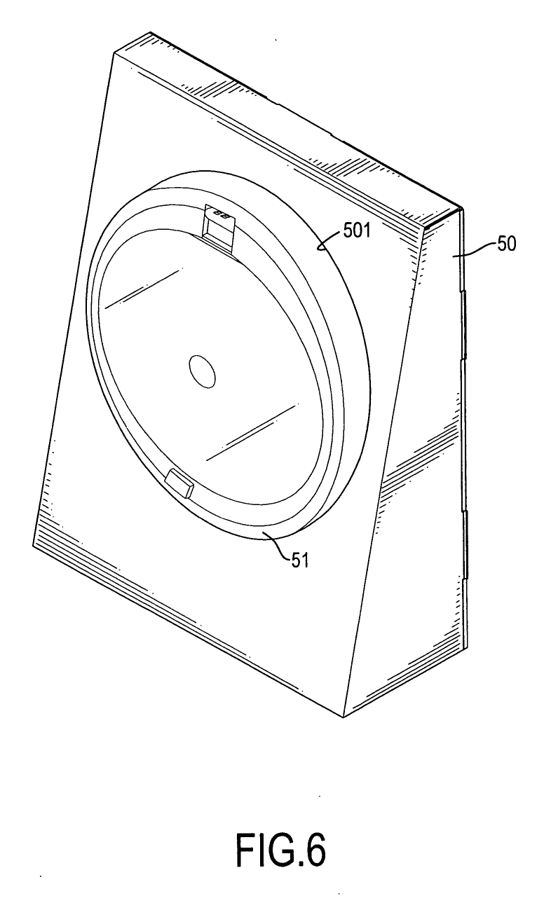

With reference to FIG. 6, the UHF and VHF antennas (11, 12) can be folded and held in the base (10) so that the entire size of the folded indoor television antenna assembly is reduced and compact. The indoor television antenna assembly in accordance with the present invention can use a specific eye-catching package to enclose the antennas. The package comprises an outer paper box (50) and a see-through case (51). The outer paper box (50) has a presentation window (501). The indoor television antenna is mounted in the presentation window (501) and is covered by the see-through case (51) so that the consumers can easily and conveniently select the indoor television antenna when considering purchase in a retail store.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A collapsible indoor television antenna assembly comprising:
a base with a top and a bottom and having
a top recess; and
an annular rib with a pivot slot formed on the top of the base, defining the top recess and comprising
a latch retractably mounted in the annular rib and extended into the top recess; and
a release button mounted on the annular rib and connecting to and retracting the latch inward to the annular rib as the release button is pressed;
a UHF antenna pivotally mounted on the base and comprising
a pivot assembly mounted in the pivot slot; and
a disk antenna rotatably mounted on the pivot assembly and having a folded position as the disk antenna is received in the top recess, an unfolded position and a lip to engage the latch to hold the disk antenna at the folded position; and
a VHF antenna set retractably mounted in the base and comprising
two connection rods retractably and rotatably mounted in the base and each of the connection rods having an outer end; and
two dipole antennas pivotally mounted at the outer ends of the connection rods, being retracted into the base and having respectively distal tips extended out of the base.

2. The collapsible indoor television antenna assembly as claimed in claim 1, wherein
the pivot assembly comprises
a pivot rod transversally mounted in the pivot slot;
a restitution element mounted around the pivot rod; and
a pivot seat pivotally mounted on the pivot rod and connecting to the restitution element; and
the disk antenna further has a pivot junction rotatably connected to the pivot seat.

3. The collapsible indoor television antenna assembly as claimed in claim 2, wherein the restitution element is a coil spring.

4. The collapsible indoor television antenna assembly as claimed in claim 1, wherein
the base further has two parallel inner tracks;
the VHF antenna set further comprises two inner sliding blocks respectively and slidably mounted on the inner tracks; and
the inner connection rods are rotatably and respectively attached to the inner sliding blocks.
